(19) United States
(12) Patent Application Publication
(10) Pub. No.: US 2007/0044633 A1
(43) Pub. Date: Mar. 1, 2007

(54) Guitar comfort cushion apparatus

(76) Inventor: John Gregory, Forked River, NJ (US)

Correspondence Address: S. Michael Bender, P.O. Box 530-399, St. Petersburg, FL, 33747, US

(21) Appl. No.: 11/501,278

(22) Filed: Aug. 9, 2006

Related U.S. Application Data
(60) Provisional application No. 60/707,110, filed on Aug. 11, 2005.

(51) Int. Cl. G10G 5/00; G10D 3/00

(52) U.S. Cl. 84/327

(57) ABSTRACT

A comfort cushion apparatus is provided for a guitar which has a notch in the guitar body. The apparatus includes a cushion support attached to the notch and fills up the notch in the guitar body. A cushion is attached to the cushion support. The notch is present in the guitar body so that the comfort cushion apparatus serves as an armrest when fitted into the notch. The armrest can make guitar playing more comfortable and more accessible for children who are in between junior and full size guitars. In accordance with another aspect of the invention, a method is provided for making a guitar which has a comfort cushion, the method includes the steps of: obtaining a guitar; cutting a notch out the guitar body; fixing a comfort cushion support in the notch; and attaching a cushion to the cushion support.

### CROSS-REFERENCE TO RELATED APPLICATION

This application claims priority based upon my copending Provisional Application Ser. No. 60/707,110; filed Aug. 11, 2005.

### BACKGROUND OF THE INVENTION

1. Field of the Invention

The present invention relates generally to guitars, and, more particularly, to a device especially adapted for increasing the comfort of a player who is playing a guitars.

2. Description of the Prior Art

Guitars are popular musical instruments, and throughout the years, a number of innovations have been developed relating to guitars, and the following U.S. patents are representative of some of those innovations: U.S. Pat. Nos. 3,309,954, 3,251,258, 3,877,501, 4,000,678, and 6,054,642.

All of U.S. Pat. Nos. 3,309,954, 3,251,258, 3,877,501, 4,000,678, and 6,054,642 have a common characteristic which is that a conventional guitar or other conventional stringed instrument is covered by some auxiliary cover or protector. In this respect, the auxiliary covers or protectors cover large areas of the conventional guitar or other conventional stringed instrument. It has been observed by the inventor of the present invention that only certain areas of a conventional guitar or other conventional stringed instrument contact portions of the body of the user when the instrument is used. In this respect, the conventional auxiliary covers or protectors use a lot more auxiliary material that need be employed for providing a comfort zone for contacting portions of the body of the user when the instrument is used.

In view of the above, it would be desirable if a guitar or other stringed instrument were provided with a comfort zone for portions of the body of the user when the instrument is used.

Also, in view of the above, it would be desirable if a guitar or other stringed instrument were provided with a comfort zone that does not use a lot more auxiliary material than need be employed for providing only the comfort zone.

As stated above, prior art auxiliary covers or protectors are generally designed for use with conventional guitars or other conventional stringed instruments. It has been conceived by the present inventor that a conventional guitar can be modified by creating a notch in the guitar body and by creating a comfort zone in the notch that is created.

It has also been conceived by the present inventor that a comfort zone created in a guitar body can include a cushion which is especially adapted to provide comfort to a user.

It is understood by the present inventor that a cushion may muffle sound in a guitar if the sound from the guitar directly interacts with the cushion. To prevent this sound muffling from occurring, in accordance with the present invention, a guitar is provided with a cushion support that is located between the cushion and the sound chamber of the guitar.

Since a portion of walls of a sound chamber of the guitar are removed to make a notch, the present inventor has devised a sound post, located near the cushion support, to provide some sound compensation for the sound altered by removing material of the sound chamber to provide the notch. Moreover, the cushion support provides additional sound compensation for the material of the sound chamber that is removed to provide the notch.

Thus, while the foregoing body of prior art indicates it to be well known to use auxiliary devices for guitars and other stringed instruments, the prior art described above does not teach or suggest a guitar comfort cushion apparatus which has the following combination of desirable features: (1) provides a comfort zone for portions of the body of the user when the instrument is used; (2) provides a comfort zone that does not use a lot more auxiliary material than need be employed for providing only the comfort zone; (3) creates a notch in the guitar body and creates a comfort zone in the notch that is created; (4) includes a cushion which is especially adapted to provide comfort to a user; (5) provides a cushion support that is located between the cushion and the sound chamber of the guitar; and (6) provides a sound post, located near the cushion support, to provide some sound compensation for the sound altered by removing material of the sound chamber to provide the notch. The foregoing desired characteristics are provided by the unique guitar comfort cushion apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a comfort cushion apparatus for a guitar which has a notch in the guitar body. The apparatus includes a cushion support attached to the notch and fills up the notch in the guitar body. A cushion is attached to the cushion support. The notch is present in the guitar body so that the comfort cushion apparatus serves as an armrest when fitted into the notch. The armrest can make guitar playing more comfortable and more accessible for children who are in between junior and full size guitars.

In accordance with one aspect of the invention, the cushion includes a top cushion layer and a bottom cushion layer supporting the top cushion layer. The cushion can be attached to the cushion support by an adhesive layer. The cushion support can be attached to the notch by a quantity of adhesive.

Preferably, a sound post is connected orthogonally between the guitar body front panel and the guitar's rear or back panel in the proximity of the support cushion.

In accordance with another aspect of the invention, the cushion support includes support-to-cushion attachment means, and the cushion includes cushion-to-support attachment means.

Preferably, the support-to-cushion attachment means include a quantity of first hook-or-loop material, and the cushion-to-support attachment means include a quantity of complementary second hook-or-loop material that is attachable to the first hook-or-loop material, whereby the cushion is attachable to the cushion support.

In accordance with another aspect of the invention, a method is provided for making a guitar which has a comfort cushion, the method includes the steps of: obtaining a guitar; cutting a notch out the guitar body; fixing a comfort cushion support in the notch; and attaching a cushion to the cushion support.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least three preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved guitar comfort cushion apparatus which has all of the advantages of the prior art and none of the disadvantages.

It is another object of the present invention to provide a new and improved guitar comfort cushion apparatus which may be easily and efficiently manufactured and marketed.

It is a further object of the present invention to provide a new and improved guitar comfort cushion apparatus which is of durable and reliable construction.

An even further object of the present invention is to provide a new and improved guitar comfort cushion apparatus which is susceptible of a low cost of manufacture with regard to both materials and labor, and which accordingly is then susceptible of low prices of sale to the consuming public, thereby making such guitar comfort cushion apparatus available to the buying public.

Still yet a further object of the present invention is to provide a new and improved guitar comfort cushion apparatus which provides a comfort zone for portions of the body of the user when the instrument is used.

Still another object of the present invention is to provide a new and improved guitar comfort cushion apparatus that provides a comfort zone that does not use a lot more auxiliary material than need be employed for providing only the comfort zone.

Yet another object of the present invention is to provide a new and improved guitar comfort cushion apparatus which creates a notch in the guitar body and creates a comfort zone in the notch that is created.

Even another object of the present invention is to provide a new and improved guitar comfort cushion apparatus that includes a cushion which is especially adapted to provide comfort to a user.

Still a further object of the present invention is to provide a new and improved guitar comfort cushion apparatus which provides a cushion support that is located between the cushion and the sound chamber of the guitar.

Yet another object of the present invention is to provide a new and improved guitar comfort cushion apparatus that provides a sound post, located near the cushion support, to provide some sound compensation for the sound altered by removing material of the sound chamber to provide the notch.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a perspective view of a conventional guitar about to be sawed to enable conversion into a guitar with a comfort cushion apparatus showing a preferred embodiment of the guitar comfort cushion apparatus of the invention.

FIG. 2 is an exploded perspective view of a first embodiment of the guitar comfort cushion apparatus of the invention.

FIG. 3 is an exploded perspective view of a second embodiment of the guitar comfort cushion apparatus of the invention, which includes a sound post.

FIG. 4 is an assembled perspective view of the embodiment of the invention shown in FIG. 3.

FIG. 5 is an enlarged cross-sectional view of the embodiment of the invention shown in FIG. 4, taken along line 5-5 thereof.

FIG. 6 is an exploded cross-sectional view of a third embodiment of the invention which includes hook-and-loop material for affixing an outer portion of the invention to an inner portion of the invention.

### DESCRIPTION OF THE PREFERRED EMBODIMENT

With reference to the drawings, a new and improved guitar comfort cushion apparatus embodying the principles and concepts of the present invention will be described.

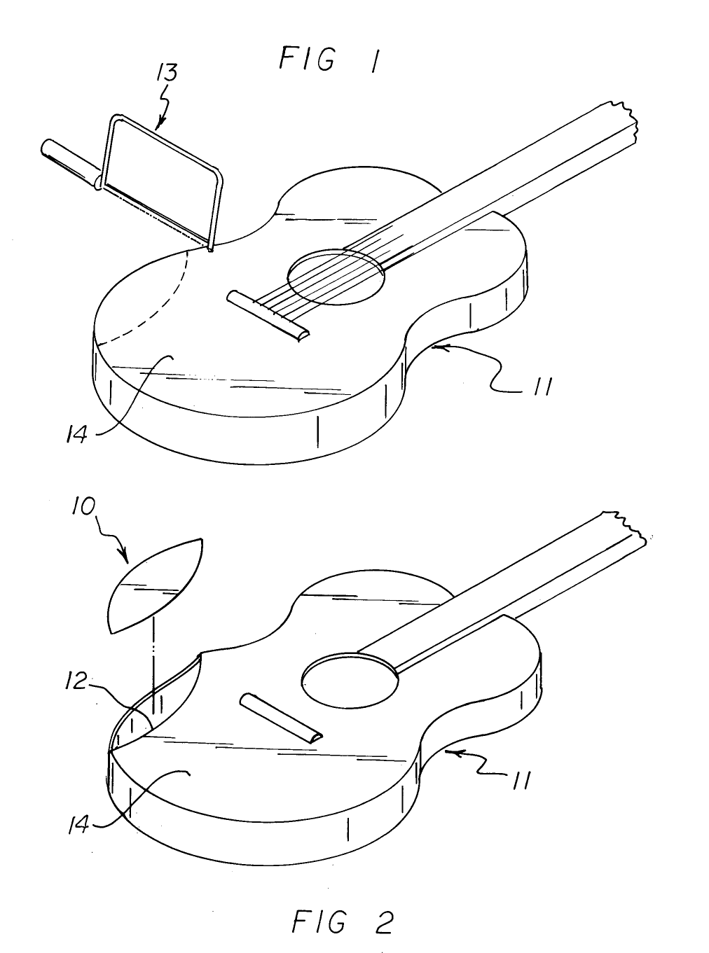

Turning to FIGS. 1-2, there is shown a first embodiment of the guitar comfort cushion apparatus of the invention generally designated by reference numeral 10. In the first embodiment, a comfort cushion apparatus 10 is provided for a guitar 11 which has a notch 12 in the guitar body 14. The apparatus includes a cushion support 16 attached to the notch 12 and fills up the notch 12 in the guitar body 14. A cushion 18 is attached to the cushion support 16. The notch 12 is present in the guitar body 14 so that the comfort cushion apparatus 10 serves as an armrest. The cushion support 16 can be made from molded plastic.

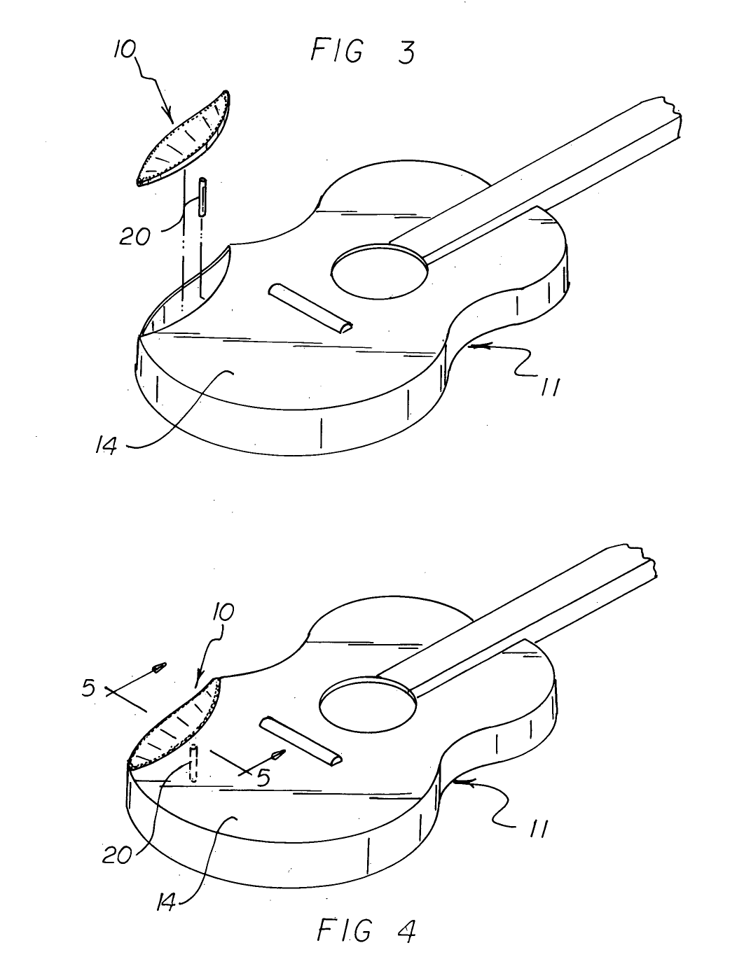

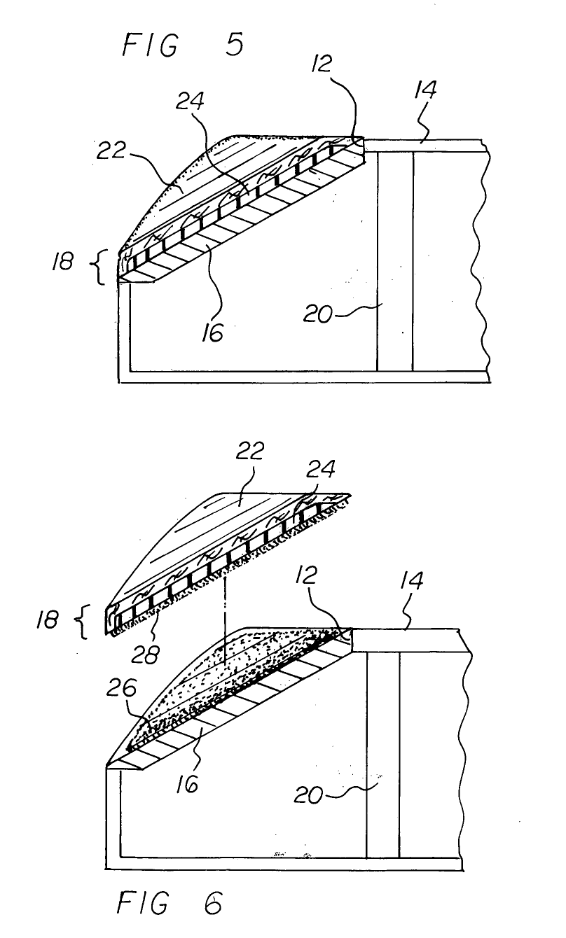

Turning to FIGS. 3-5, a second embodiment of the invention is shown. Reference numerals are shown that correspond to like reference numerals that designate like elements shown in the other figures. In addition, a sound post 20 suitably is connected orthogonally between the guitar body's front panel and rear panel, substantially as illustrated. The sound post 20 adds support and structural integrity to the guitar body 14.

With the embodiment of the invention shown in FIGS. 3-5, the cushion 18 includes a top cushion layer 22 and a bottom cushion layer 24 supporting the top cushion layer 22. The cushion 18 is attached to the cushion support 16 by an adhesive layer.

With the third embodiment of the invention shown in FIG. 6, the cushion support 16 includes support-to-cushion attachment means, and the cushion 18 includes cushion-to-support attachment means.

Preferably, the support-to-cushion attachment means include a quantity of first hook-or-loop material 26, and the cushion-to-support attachment means include a quantity of complementary second hook-or-loop material 28 that is attachable to the first hook-or-loop material 26, whereby the cushion 18 is attachable to the cushion support 16. Alternatively, the support-to-cushion attachment means and the cushion-to-support attachment means can be complementary snap and snap receiver elements.

The cushion 18 can be made of washable material. The cushion 18 can be made in various fabrics and colors, even leather.

The cushion 18 and the cushion support 16 can be provided as a unified, integrated structure. For example, that unified structure can include a layer of aluminum or vinyl, a layer of cardboard, a layer of sponge pad, a sponge pad cover, and a top cover.

In accordance with another aspect of the invention, method of making a guitar which has a comfort cushion includes the steps of: obtaining a guitar 11; cutting a notch out the guitar body; and fixing a comfort cushion support in the notch.

The guitar 11 with the notch 12 in the guitar body 14 can be factory made. In this respect, the comfort cushion apparatus 10 can be combined with the guitar 11 at the factory.

Alternatively, the comfort cushion apparatus 10 can be provided in a kit form so that a conventional guitar 11 can be retrofitted with a comfort cushion apparatus 10 of the invention.

The comfort cushion apparatus 10 can be designated “Comfort Acoustic”.

The components of the guitar comfort cushion apparatus of the invention can be made from inexpensive and durable metal, plastic, rubber, and cloth materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved guitar comfort cushion apparatus that is low in cost, relatively simple in design and operation, and which may advantageously be used to provide a comfort zone for portions of the body of the user when the instrument is used. With the invention, a guitar comfort cushion apparatus provides a comfort zone that does not use a lot more auxiliary material than need be employed for providing only the comfort zone. With the invention, a guitar comfort cushion apparatus is provided which creates a notch in the guitar body and creates a comfort zone in the notch that is created. With the invention, a guitar comfort cushion apparatus is provided which includes a cushion which is especially adapted to provide comfort to a user. With the invention, a guitar comfort cushion apparatus provides a cushion support that is located between the cushion and the sound chamber of the guitar. With the invention, a guitar comfort cushion apparatus provides a sound post, located near the cushion support, to provide some sound compensation for the sound altered by removing material of the sound chamber to provide the notch.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U. S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A comfort cushion apparatus for a guitar which has a notch in a guitar body, comprising:
a cushion support attached to the notch and filling up the notch in the guitar body, and
a cushion attached to said cushion support.

2. The apparatus of claim 1 wherein said cushion includes a top cushion layer and a bottom cushion layer supporting said top cushion layer.

3. The apparatus of claim 1 wherein said cushion is attached to the cushion support by an adhesive layer.

4. The apparatus of claim 1 wherein said cushion support is attached to the notch by a quantity of adhesive.

5. The apparatus of claim 1, further including:
a sound post connected orthogonally between a guitar body front panel and a guitar rear or back panel in the proximity of said support cushion.

6. The apparatus of claim 1 wherein:
said cushion support includes support-to-cushion attachment means, and
said cushion includes cushion-to-support attachment means.

7. The apparatus of claim 6 wherein:
said support-to-cushion attachment means include a quantity of first hook-or-loop material, and
said cushion-to-support attachment means include a quantity of complementary second hook-or-loop material that is attachable to said first hook-or-loop material, whereby said cushion is attachable to the cushion support.

8. A method for making a guitar which has a comfort cushion, the method includes the steps of:
obtaining a guitar;
cutting a notch out the guitar body;
fixing a comfort cushion support in the notch; and
attaching a cushion to the cushion support.
